(19) United States
(12) Patent Application Publication
(10) Pub. No.: US 2007/0265005 A1
(43) Pub. Date: Nov. 15, 2007

(54) Network selection for prioritized access via wireless access networks

(75) Inventor: Paul K. Sitch, Palo Alto, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/797,624

(22) Filed: May 4, 2007

Related U.S. Application Data
(60) Provisional application No. 60/797,666, filed on May 5, 2006.

(51) Int. Cl. H04Q 7/20

(52) U.S. Cl. 455/435.1

(57) ABSTRACT

The present invention relates to a method, terminal device, network element, and computer program product for selecting a network in order to provide access to a prioritized service via a wireless access network (200), wherein an identifier portion in an authentication response is set to a first service-specific default identifier portion dedicated to the prioritized service in a home network of a terminal device (10). Then, at least one network list, which is advertised by at least one wireless access network (200) if the home network cannot be accessed based on the service-specific default identifier portion, is used to select a visitor network indicated in the at least one network list as a network which supports the prioritized service, and an identifier portion in a subsequent authentication response is set to a second service-specific default identifier portion dedicated to the prioritized service in the selected visitor network. Thereby, the likelihood of selecting a valid network that supports the prioritized service can be improved.

### CROSS REFERENCE TO RELATED APPLICATION

This application claims priority of U.S. Provisional Patent Application Ser. No. 60/797,666 entitled Network Selection for Prioritized Access via Wireless Access Networks, filed on May 5, 2006, the contents of which are hereby incorporated by reference.

### FIELD OF THE INVENTION

The present invention relates to a method, terminal device, network element, and computer program product for selecting a network in order to provide access to a prioritized service via a wireless access network, such as an interworking wireless local area network (I-WLAN).

### BACKGROUND OF THE INVENTION

The growth of public WLANs provides an opportunity for appropriately-equipped terminal devices (or user equipments (UE) in 3rd generation terminology) to access cellular home networks and visited networks via such WLANs. WLANs which provide such an interworking functionality are therefore referred to as I-WLANs. The I-WLANs are connected to Private Land Mobile Networks (PLMNs) enabling UEs to access network services on home networks (HPLMNs) and visited networks (VPLMNs).

Wireless devices will be bound by law to support emergency calls. Reporting of an emergency should be possible even when no session is currently active over a particular radio channel of a multi access device, i.e. the user is presently not attached to any radio, or a subscriber identity module (SIM) or Universal Mobile Telecommunications System SIM (USIM) is presently not inserted in the device.

### SUMMARY OF THE INVENTION

It is therefore an object of the present invention to provide a network selection scheme for prioritized access via a wireless access network, by means of which an automatic PLMN selection can be achieved for the case where the user is attaching to the wireless access network in order to perform a prioritized access, such as an emergency call.

This object is achieved by a method of selecting a network for providing access to a prioritized service via a wireless access network, said method comprising the steps of:
setting an identifier portion in an authentication response to a first service-specific default identifier portion dedicated to said prioritized service in a home network of a terminal device;
selecting from at least one network list, which is advertised by at least one wireless access network if said home network cannot be accessed based on said service-specific default identifier portion, a visitor network indicated in said at least one network list as a network which supports said prioritized service; and
setting an identifier portion in an subsequent authentication response to a second service-specific default identifier portion dedicated to said prioritized service in said selected visitor network.

Additionally, the above object is achieved by terminal device for providing access to a prioritized service via a wireless access network, said terminal device comprising setting means for setting an identifier portion in an authentication response to a first service-specific default identifier portion dedicated to said prioritized service in a home network of a terminal device; for selecting from at least one network list, which is advertised by at least one wireless access network if said home network cannot be accessed based on said service-specific default identifier portion, a visitor network indicated in said at least one network list as a network which supports said prioritized service; and for setting an identifier portion in an subsequent authentication response to a second service-specific default identifier portion dedicated to said prioritized service in said selected visitor network.

Furthermore, the above object is achieved by a network element of a wireless access network for providing access to an emergency call service via said wireless access network, said network element being configured to advertise a network list comprising an indicator for indicating networks which support said emergency call service.

Accordingly, the likelihood of selection of a valid network that supports the emergency call procedure can be improved. In particular, if the home network (e.g. HPLMN) supports the emergency call service specific realm, it is selected at highest priority. If it does not support the emergency call procedure, a visitor network (e.g. VPLMN) that supports the prioritized service and is known by the user to be a favored visitor network is prioritized over the choice of the non-supporting home network.

The first and second default identifier portions may be realm parts or portions of realm parts of network access identifiers. The prioritized service may be an emergency service or an emergency call or an other service requiring prioritized access.

Furthermore, the advertised at least one network list may indicate available networks and service-specific default identifier portions of those networks which support the prioritized service, wherein the second service-specific default identifier portion may be derived from the at least one network list. As an example, the selection may be comprise a comparison of the advertised at least one network list with at least one of a user defined network list and an operator defined network list stored at the terminal device, and the visitor network may be selected based on the result of the comparison.

If a visitor network also cannot be accessed based on a service-specific default identifier portion, a fall-back to a network selection procedure which does not use any service-specific default identifier portion may be initiated.

Further advantageous modifications are defined in dependent claims.

### BRIEF DESCRIPTION OF THE DRAWINGS

The present invention will now be described based on an embodiment with reference to the accompanying drawings in which:

FIG. 1 shows a schematic diagram indicating a network architecture in which the present invention can be implemented;

FIG. 2 shows a schematic signaling and processing diagram of a network advertisement of available PLMNs containing also service specific emergency call realms at the PLMN;

FIG. 3 shows a schematic flow diagram of an automatic network selection procedure according to the embodiment; and

FIG. 4 shows schematic block diagrams of a terminal device and network devices according to the embodiment.

### DESCRIPTION OF THE EMBODIMENT

In the following, an embodiment of the present invention will be described based on an I-WLAN network architecture as defined in the 3GPP specification TS22.234 V7.2.0, Release 7.

Usually, emergency reports initiated by pulling a switch or calling an emergency number are generally treated in a prioritized manner, so that access is readily available to invoke the emergency alarm. However, wireless devices may not have reliable functions or be used reliably during an emergency, so that entering of passwords or other authentication processes may not be done correctly. Moreover, a wireless device may be near a network or access network but not associated to that network. Therefore, authorization is not needed before the alarm is sounded or contact is made to the emergency center in order to expedite the emergency call.

I-WLAN access is defined in specifications TS 23.234, 33.234, 24.234 and 29.234 of the 3rd generation partnership project (3GPP). For direct IP access (Scenario 2) and 3GPP IP access (Scenario 3), an Extensible Authentication Protocol (EAP) SIM/AKA (Authentication and Key Agreement) procedure is used for authentication, wherein authorization is done based on a subscriber check against information held at a subscriber database, e.g., a home subscriber server (HSS).

In the following, a conventional PLMN selection procedure as defined in 3GPP TS 22.234, 23.234 and 29.234 is described.

Service set identifiers (SSIDs) are used as names of WLANs or to differentiate different service offerings within a given WLAN. The corresponding 3GPP terminology is “Wireless LAN Service Identifier” (WSID). The SSID/WSID on wireless clients can be set either manually, by entering the SSID/WSID into the client network settings, or automatically, by leaving the SSID/WSID unspecified or blank. A network administrator often uses a public SSID/WSID, that is set on the access point and broadcast to all wireless devices in range. SSIDs/WSIDs are case sensitive text strings, e.g., a sequence of alphanumeric characters (letters or numbers) and may have a maximum length of 32 characters.

In the context of 3GPP PLMN network selection, selection of and association with a given SSID/WSID is a means to an end: the key goal to find the most suitable PLMN “behind” the (possibly) multiple SSIDs/WSIDs available. In order not to confuse the mobile user, the 3GPP defined I-WLAN PLMN selection procedure has been designed to hide as far as possible the SSIDs/WSIDs and to only present the user with available PLMNs. In this way, the I-WLAN PLMN selection procedure from the user perspective is as similar as possible to the cellular (GPRS/UMTS case). Only in exceptional cases WSIDs/SSIDs are presented to the user (e.g. in manual PLMN selection where a given PLMN is available via more than one WSID/SSID).

In an automatic PLMN selection mode according to TS 23.234, the WLAN UE scans for all available WSIDs using passive scan and/or active scans. Once the WLAN UE has a list of all available WSIDs, it performs I-WLAN and PLMN discovery and selection procedures. The WLAN UE associates with a given WSID and network discovery is performed. When there is more than one available WSID and the WLAN UE contains WSID preference lists, the association is done in the order of these lists.

In the automatic selection procedure, the WLAN UE decorates the NAI with the root NAI (private_user_id@HPLMN). If authentication to the HPLMN succeeds (i.e. EAP-Success notification is received), through a particular WSID, then the selection procedure is stopped. Otherwise, if no direct connection to the HPLMN can be found via the particular WSID and if a network advertisement information is received (i.e. EAP-Identity/Request notification is received), then the PLMN list thus received is stored. The WLAN UE continues by selecting the next available WSID, associating with it and performing network discovery.

For the purpose of selecting a PLMN two lists may be present in the USIM Integrated Circuit Card (UICC), namely a “User Controlled PLMN Selector list for I-WLAN” and an “Operator Controlled PLMN Selector list for I-WLAN”. It is not mandatory for the UICC to support these lists, however if the “Operator Controlled PLMN Selector list for I-WLAN” is supported then the “User Controlled PLMN Selector list for I-WLAN” shall also be present. Both lists contain the preferred PLMNs for I-WLAN in priority order, and the “User Controlled PLMN Selector list for I-WLAN” has higher priority than the “Operator Controlled PLMN Selector list for I-WLAN”.

If no direct connection to the HPLMN is found through any of the available WSIDs, in the next step of the automatic selection procedure, the ‘User Controlled PLMN Selector list for I-WLAN’, the ‘Operator Controlled PLMN Selector list for I-WLAN’, as detailed above are used to select the best matching PLMN. Then, the I-WLAN access network (AN) that supports the best match PLMN is selected. If more than one I-WLAN AN supports the best matched PLMN, the I-WLAN AN having the highest priority SSID is selected, if ‘I-WLAN identities’ preference lists are available.

An association is established with the AP selected in the preceding step and authentication is attempted with the best match PLMN.

The above requirements may be met through explicit EAP-based procedures together with the use of generic ‘I-WLAN identities’ preference lists and selection algorithms for the use of those preference lists.

The provision of emergency calls can be facilitated via network support of a service specific realm within a given PLMN (e.g. “emcall.PLMN”). However, it is not clear how such a service specific realm could be used by the UE during the network selection procedure.

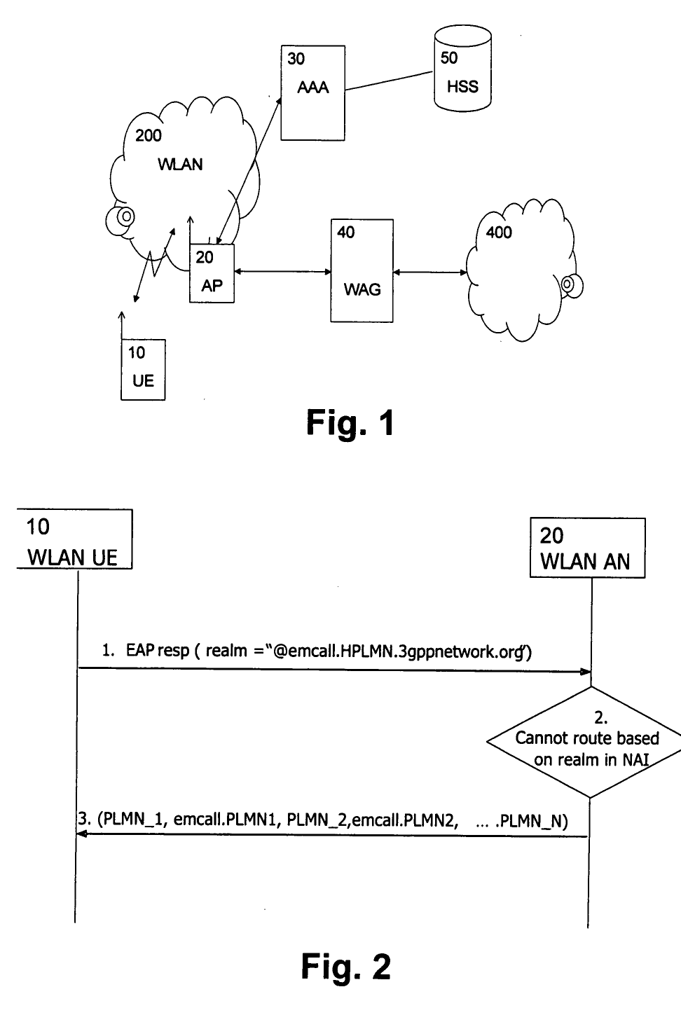

FIG. 1 shows a schematic block diagram of a corresponding network architecture, wherein a UE 10 can be connected via an air interface to an access point (AP) 20 of a WLAN 200. Authentication and authorization is controlled by an AAA (Authentication, Authorization and Accounting) server 30 based on information obtained from a subscriber database, such as a HSS 50. After authorization and authentication, the UE 10 can be connected via the WLAN 200, which serves as an interworking network, to a WLAN access gateway (WAG) 40 providing access to a Public Land Mobile Network (PLMN) 400 (via a Packet Data Gateway (PDG)) from where it has access to external networks, such as an IP based network, e.g. an IP multimedia subsystem (IMS).

Before allowing entities to access a network and its associated resources, the general mechanism is to authenticate the entity (a device and/or user) and then allow authorization based on the identity. The most common access control is binary, i.e. it either allows access or denies access based on membership in a group. The authentication is based on a three-party model, which involves the supplicant which requires access, the authenticator which grants access, and the authentication server which gives permission. The supplicant has an identity and some credentials to prove that it is true what it claims to be. The supplicant is connected to a network through an authenticator's port that is access controlled. The authenticator itself does not know whether an entity can be allowed access. This is the function of the authentication server. The supplicant initiates an access request, and the authenticator starts a message exchange based on an authentication protocol, e.g. the Extensible Authentication Protocol (EAP). At some point, the authenticator communicates with the authentication server, which decides on an authentication protocol. A set of exchanges then occurs between the supplicant, the authenticator, and the authentication server. At the end of this exchange, a success or failure state is reached. If the authentication succeeds, the authenticator allows network access to the supplicant through the port. The authenticator also keeps a security context of the pair of supplicant and authenticator's port.

The access media can be any medium selected from Ethernet, Token Ring, WLAN, or the original media in a serial Point-to-Point protocol (PPP) link. EAP specifications provide a framework for exchanging authentication information after the link layer has been established. This exchange does not even need IP. It is a function of the transport protocol layer to specify how EAP messages can be exchanged over the access network. The actual authentication process is the one that defines how and what credentials should be exchanged.

In the present example, the access is to be performed via the WLAN 200 using EAP, which is a flexible protocol used to carry arbitrary authentication information and which is defined in the IETF (Internet Engineering Task Force) specification RFC 2284.

In the architecture of FIG. 1, an EAP authentication procedure is initiated in a WLAN-specific way. All EAP packets are transported over the WLAN interface encapsulated within a WLAN technology specific protocol. A number of EAP request and EAP response message exchanges is executed between the AAA server 30 and the UE 10. The amount of round trips depends e.g. on the utilized EAP type. Information stored in and retrieved from the HSS 50 may be needed to execute a certain EAP message exchanges. Information to execute the authentication with the accessed user is also retrieved from the HSS 50. This information retrieval is needed only if necessary information to execute the EAP authentication is not already available in the AAA server 30.

In general, a user name part of the provided NAI identity is utilized to identify a user. During information retrieval the HSS 50 checks if there is an AAA server already registered to serve for the user. In case the HSS 50 detects such another AAA server, it provides the current AAA server 30 with the previously registered AAA server address. The authentication signaling is then routed to the previously registered AAA server. The subscriber's WLAN related profile is retrieved from the HSS 50. If the EAP authentication and authorization was successful, the AAA server 30 sends an access accept message to the WLAN 200. In this message, the AAA server 30 includes EAP success message, keying material derived from the EAP authentication as well as a connection authorization information to the WLAN 200. The WLAN 200 stores the keying material and authorization information to be used in communication with the authenticated UE 10. Then, the WLAN 200 informs the UE 10 about the successful authentication and authorization with an EAP success message.

For a specific I-WLAN emergency call case, during a Scenario 2 “attach” to the WLAN 200, the UE 10 must indicate a user name NAI as identity in the EAP signaling exchange. The realm part of this NAI is used to route the request to the relevant HPLMN for the user. This realm part may be in the form of an Internet domain name, e.g. “operator.com”, as specified in IETF specification RFC 1035. When attempting to authenticate within WLAN access, the UE 10 can derive the home network domain name from the International Mobile Subscriber Identity (IMSI) provided in the UICC.

According to the preferred embodiment, an emergency call service specific realm is used for the HPLMN (e.g. “emcall.HPLMN”) instead of the plain HPLMN as the realm to be used to which the WLAN UE 10 tries to automatically find a direct connection to the HPLMN.

Further, if this fails, the WLAN UE 10 compiles a list of VPLMNs that support the emergency call service specific realm and selects a VPLMN based on a comparison between this list and the user and operator defined PLMN lists stored in the UICC or SIM/USIM card. It is noted that the operator and user lists do not need to contain entries such as “emcall.VPLMN”. Just a straight comparison to the VPLMN is sufficient.

If both above options fail, a fall back to the conventional PLMN selection procedure described in the introductory portion may be initiated.

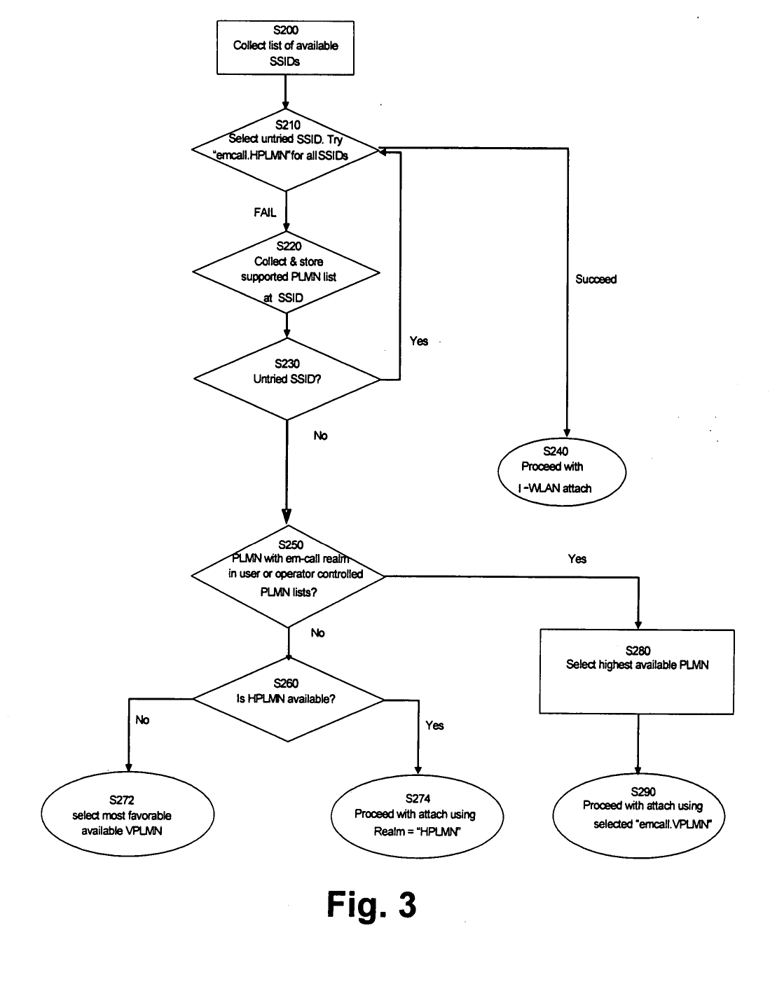

In the following, a specific implementation of the proposed automatic network selection procedure in a I-WLAN environment is described with reference to FIGS. 2 and 3.

FIG. 2 shows a schematic diagram indicating signaling between the WLAN UE 10 and the WLAN AP 20 for a network advertisement of available PLMNs, containing also service specific emergency call realms at the PLMN.

This network advertisement is optionally sent in step 1 by the WLAN AN if it does not have a routing relationship with the HPLMN (i.e. it cannot route the indicated realm in the NAI (in this case emcall.HPLMN.3gppnetwork.org). In step 2, the WLAN AP 20 recognizes that it cannot route messages based on the realm in the NAI. In response thereto, the WLAN AP 20 initiates an advertisement procedure including a list of supported emergency call specific realms (“emcall.PLMN”), which might look like “PLMN_{—}1, emcall.PLMN1, PLMN_{—}2, emcall.PLMN2, . . . PLMN_N”.

FIG. 3 shows a schematic flow diagram of an automatic network selection procedure according to the embodiment, as performed by the WLAN UE 10, which is based on the conventional selection procedure described in the introductory portion and which is however modified to enhance and improve prioritized access, e.g., emergency service specific realms. In particular, the proposed enhanced automatic network selection procedure is modified to enable initial use of an emergency call specific realm in the HPLMN and checking whether a VPLMN supporting an emergency service specific realm is available. Of course, the proposed selection procedure can be adapted to use other specific identifying or addressing functions in a similar way. One other embodiment could be to prioritize all VPLMNs that explicitly support the emergency call service (regardless of whether they are on any preferred PLMN lists stored by the terminal or smart card. Only when these emergency call VPLMNs are exhausted does the PLMN selection procedure revert back to that of the conventional case.

In step S200, the WLAN UE 10 collects a list of available SSIDs. Then, in step S210, it selects an untried SSID and tries to attach to the HPLMN by using a realm “emcall.HPLMN” for all available SSIDs. If the attach procedure is successful, the WLAN UE 10 proceeds with the conventional I-WLAN attach (step S240), e.g., as described in the introductory portion. Otherwise, if the attach fails, the WLAN UE 10 collects and stores a supported PLMN list for an SSID (step S220), as advertised for this SSID by the respective WLAN AP 20 according to the above procedure of FIG. 2. Then, in step S230, the WLAN UE 10 checks in step S230 whether other untried SSIDs are available. If so, the procedure returns to step S210, selects a new untried SSID and initiates a new attach procedure until all untried SSIDs have been used.

Thereby, the emergency specific realm is used in the HPLMN via all available SSIDs to try to find a default connection for prioritized access to the HPLMN.

If none of the attach procedures has led to a successful attach to the HPLMN, available emergency service specific realms obtained from the advertisement(s) are listed at the WLAN UE 10 and it is checked in step S250 whether any of the listed PLMNs that have emergency service specific realms available appear in the user or operator defined PLMN lists described in the introductory portion. If so, the highest PLMN on the user defined list is selected, if available. Else, the highest PLMN on the operator defined list is selected (step S280). Thereafter, the WLAN UE 10 proceeds with the attach using the selected emergency service specific realm (e.g. “emcall.VPLMN”) in the selected PLMN.

On the other hand, if the WLAN UE 10 determines in step S250 that no PLMN with emergency service specific realm appears on the user or operator defined lists, it checks in step S260 whether the HPLMN is available. If so, the WLAN UE 10 proceeds in step S274 with the conventional attach using the unspecific realm “HPLMN”. If the HPLMN is determined in step S260 to be not available, the WLAN UE 10 proceeds in step S272 with the conventional PLMN selection where the HPLMN is not available, i.e., selects the most favoured available VPLMN.

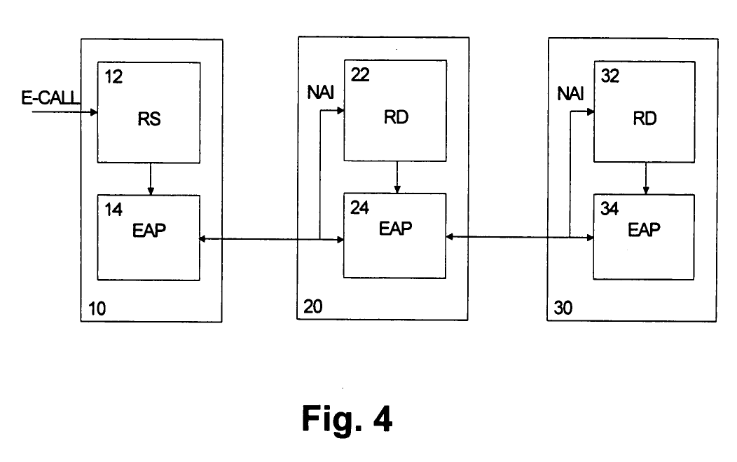

FIG. 4 shows a schematic block diagram indicating the devices involved in the subsequent authentication process and specific units and functions thereof.

When an emergency call is initiated by a user at the WLAN UE 10, a corresponding realm setting function or unit 12 determines the emergency specific default service realm based on the above automatic network selection procedure and generates a corresponding NAI forwarded to a EAP control unit 14 which generates the EAP ID response. This response is then forwarded to the AP 20 of the WLAN 200 where the NAI is extracted and supplied to a realm detection function or unit 22 which detects the default realm and controls an EAP control unit 24 to select the predetermined AAA server 30 and forward the EAP ID response to the selected or determined AAA server 30. At the default AAA server 30, the NAI is again extracted and detected at a realm detection unit 32. Based on the detection of the default realm part, the realm detection function or unit 32 controls an EAP control unit 34 to initiate a predetermined EAP method for emergency calls.

It is noted, that default realm parts may be provided for different prioritized calls so as to route EAP ID requests to at least one AAA server and initiate more than one specific EAP method. Such prioritized calls may include a fire alarm call, an emergency doctor call, etc.

The proposed network selection procedure according to the embodiment improves the likelihood of selection of a valid PLMN that supports the emergency call procedure. In particular, if the HPLMN supports the emergency call service specific realm, it is selected first. If it does not support the emergency call procedure, a VPLMN that has a roaming relationship with the HPLMN and supports emergency call service is promoted over the choice of the HPLMN. This is an important improvement considering that the next step after WLAN attach is to set up an I-WLAN tunnel to a packet data gateway (PDG) supporting the emergency WLAN access point name (W-APN). For roaming cases, the PDG must be in the VPLMN—not in the HPLMN. Thus, a roaming case where the VPLMN supports emergency service is more appropriate than a non-roaming case where the HPLMN may not.

In summary, a method, terminal device, network element, and computer program product for selecting a network in order to provide access to a prioritized service via a wireless access network have been described, wherein an identifier portion in an authentication response is set to a first service-specific default identifier portion dedicated to the prioritized service in a home network of a terminal device Then, at least one network list, which is advertised by at least one wireless access network if the home network cannot be accessed based on the service-specific default identifier portion, is used to select a visitor network indicated in the at least one network list as a network which supports the prioritized service, and an identifier portion in a subsequent authentication response is set to a second service-specific default identifier portion dedicated to the prioritized service in the selected visitor network. Thereby, the likelihood of selecting a valid network that supports the prioritized service can be improved.

The processing steps described in connection with FIG. 3 may be implemented as concrete hardware entities or units, or alternatively may be based on software routines controlling data processors or computer devices provided in the terminal device or a smart card or similar device inserted thereto. Consequently, the embodiment may be implemented as a computer program product comprising code means for generating each individual step of the networks selection procedure according to the embodiment when run on a computer device or data processor of the terminal device, e.g, WLAN UE.

Moreover, it is to be noted that the above described automatic network selection scheme is by no means restricted to the above embodiment and can be used in connection with any authentication procedure which is based on an identifier portion. In particular, any information which can serve as an emergency service specific unique default identifier portion dedicated to a predetermined prioritized call can be used instead of the above described realm part of the NAI. Moreover, any suitable service-specific authentication method can be used for authentication. The selection of a VPLMN may be based on a comparison between at least one network list, advertised by at least one access network, and at least one of the user and operator defined PLMN lists stored in the UICC or SIM/USIM card. The preferred embodiments may thus vary within the scope of the attached claims.

1. A method of selecting a network for providing access to a prioritized service via a wireless access network, said method comprising:
a) setting an identifier portion in an authentication response to a first service-specific default identifier portion dedicated to said prioritized service in a home network of a terminal device;
b) selecting from at least one network list, which is advertised by at least one wireless access network if said home network cannot be accessed based on said service-specific default identifier portion, a visitor network indicated in said at least one network list as a network which supports said prioritized service; and
c) setting an identifier portion in a subsequent authentication response to a second service-specific default identifier portion dedicated to said prioritized service in said selected visitor network.

2. A method according to claim 1, wherein said first and second default identifier portions comprise at least or portions of realm parts of network access identifiers.

3. A method according to claim 1, wherein said prioritized service is an emergency service or an emergency call.

4. A method according to claim 1, wherein said at least one network list indicates available networks and service-specific default identifier portions of networks which support said prioritized service, and wherein said second service-specific default identifier portion is derived from said at least one network list.

5. A method according to claim 1, wherein said selecting step comprises comparing said at least one network list with at least one of a user defined network list and an operator defined network list stored at said terminal device, and selecting said visitor network based on a result of said comparison.

6. A method according to claim 1, further comprising initiating a fall-back to a network selection procedure which does not use any service-specific default identifier portion, if a visitor network also cannot be accessed based on a service-specific default identifier portion.

7. A terminal device for providing access to a prioritized service via a wireless access network, said terminal device comprising first means for setting an identifier portion in an authentication response to a first service-specific default identifier portion dedicated to said prioritized service in a home network of a terminal device; means for selecting from at last one network list, which is advertised by at least one wireless access network if said home network cannot be accessed based on said service-specific default identifier portion, a visitor network indicated in said at least one network list as a network which supports said prioritized service; and second means for setting an identifier portion in an subsequent authentication response to a second service-specific default identifier portion dedicated to said prioritized service in said selected visitor network.

8. A terminal device according to claim 7, wherein said first and second default identifier portions comprise at least portions of realm parts of network access identifiers.

9. A terminal device according to claim 7, wherein said predetermined prioritized service is an emergency call or an emergency service.

10. A terminal device according to claim 7, wherein said first means for setting is configured to compare said at least one network list with at least one of a user defined network list and an operator defined network list stored at said terminal device and to select said visitor network based on the comparison result.

11. A terminal device according to claim 7, wherein said first means for setting is configured to initiate a fall-back to a network selection procedure which does not use any service-specific default identifier portion, if a visitor network also cannot be accessed based on a service-specific default identifier portion.

12. A network element of a wireless access network for providing access to an emergency call service via said wireless access network, said network element being configured to advertise a network list comprising an indicator for indicating networks which support said emergency call service.

13. A network element according to claim 12, wherein said network element is configured to add a unique service-specific default identifier portion to each of network supporting said emergency call service.

14. A network element according to claim 13, wherein said unique service-specific default identifier portion comprises at least a portion of a realm part of a network access identifier.

15. A network element according to claim 12, wherein said network element is an access point of a wireless local area network.

16. A computer program product comprising code means embodied on a computer readable medium, that when executed by a processor, are configured to control a method for selecting a network, comprising the steps of:
a) setting an identifier portion in an authentication response to a first service-specific default identifier portion dedicated to a prioritized service in a home network of a terminal device;
b) selecting from at least one network list, which is advertised by at least one wireless access network, if said home network cannot be accessed based on said service-specific default identifier portion, a visitor network indicated in said at least one network list as a network which supports said prioritized service; and
c) setting an identifier portion in an subsequent authentication response to a second service-specific default identifier portion dedicated to said prioritized service in said selected visitor network.

17. The computer program product of claim 16, wherein the computer program product is stored on a smart card.

18. A system for providing access to a prioritized service via a wireless access network, said system comprising a terminal device having a setting means for setting an identifier portion in an authentication response to a first service-specific default identifier portion dedicated to said prioritized service in a home network of a terminal device; for selecting from at last one network list, which is advertised by at least one wireless access network if said home network cannot be accessed based on said service-specific default identifier portion, a visitor network indicated in said at least one network list as a network which supports said prioritized service; and for setting an identifier portion in an subsequent authentication response to a second service-specific default identifier portion dedicated to said prioritized service in said selected visitor network.

19. A system for providing access to a prioritized service via a wireless access network, said system comprising a network element of a wireless access network for providing access to an emergency call service via said wireless access network, said network element being configured to advertise a network list comprising an indicator for indicating networks which support said emergency call service.

20. A system for providing access to a prioritized service via a wireless access network, said system comprising: a terminal device having a setting module configured to set an identifier portion in an authentication response to a first service-specific default identifier portion dedicated to said prioritized service in a home network of a terminal device; a first selecting device configured to select from at last one network list, which is advertised by at least one wireless access network if said home network cannot be accessed based on said service-specific default identifier portion, a visitor network indicated in said at least one network list as a network which supports said prioritized service; and a second selecting device for setting an identifier portion in an subsequent authentication response to a second service-specific default identifier portion dedicated to said prioritized service in said selected visitor network.
